(19) United States
(12) Patent Application Publication
(10) Pub. No.: US 2006/0136125 A1
(43) Pub. Date: Jun. 22, 2006

(54) Digital map display

(76) Inventor: Beng San Chua, Johor Bahru (MY)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 10/547,683

(22) PCT Filed: Mar. 23, 2004
(86) PCT No.: PCT/SG04/00068

§ 371 Date: Aug. 30, 2005

(30) Foreign Application Priority Data
Apr. 2, 2003 (AU) PI 20031231

(51) Int. Cl. G01C 21/32

(52) U.S. Cl. 701/208; 340/995.1

(57) ABSTRACT

A digital map display having a zooming method and a zooming device is disclosed. By determining the number of entities such as buildings at the position, a desirable zoom scale for the display of a digital map for that location is set using a predetermined ration of total entities. This means that when traveling the user does not have control the digital map display to have an understanding of the current surroundings, and the required direction of travel.

### FIELD OF THE INVENTION

The present invention relates to a digital map display and refers particularly, though not exclusively, to a digital map display for screens of portable and non-portable devices.

### DEFINITIONS

Throughout this specification a reference to a road is to be taken as including a reference to a street, lane, alley, place, avenue, close, highway, expressway, parkway, route, thoroughfare, track, way, boulevard, roadway, terrace, and any other passage over which a motor vehicle can pass.

### BACKGROUND TO THE INVENTION

Digital maps are put into electronic form so as to be displayed on the display screen of electronic devices such as, for example, a navigation system including an in-vehicle navigation system, portable digital assistance (PDA), mobile telephone, tablet computer, notebook computer, laptop computer. The common element to all such devices is that they have a display screen.

The prior art includes numerous such devices for a user to operate to instruct a system to enlarge or reduce the displayed portion of the digital map within the display screen. These generally require the user to use prescribed buttons to effect the scale change; or by changing the scale setting while watching the display screens. An example is U.S. Pat. No. 6,411,274. U.S. Pat. No. 5,315,298 discloses a method of zooming by determining whether or not there is a boundary of the areas having different levels of detail on the screen of a display. U.S. Pat. No. 4,675,676 discloses the automatic reduction or enlargement of a displayed map from a reduced or enlarged map data storage device in accordance with the distance between the present position of a vehicle and a destination. US Patent Application 2003/0023376 and US Patent Application 2003/0038787 disclose a system based on the vehicle position and changes in the area the vehicle is approaching on the roadmap such that the scaling factor of the map is changed by a scaling factor. However, it is widely recognized that a person using a navigation system cannot devote their full attention to the screen display when involved with another task. This is particularly critical when driving a vehicle such as, for example, an emergency vehicle such as an ambulance, fire truck or police vehicle. At such times, it is important that the driver's attention be directed to the driving of the vehicle, and that the operator has both hands free to operate the controls of the vehicle. Most of the time the driver can only glance at the display screen in the same manner as for a rear vision mirror and side mirrors of the car. Authorities in many countries recognize this by banning the use of mobile telephones when driving, unless a hands-free kit is used. It is difficult to drive a vehicle when one hand is occupied in operating display screen controls while the vehicle is in motion.

As for the automatic reduced or enlarged map in accordance with the separating distance between the present position of a vehicle and a destination, the user will not know their close surroundings to be able to make correct judgments on the next road to use. Even though routing may be provided by the system, the dynamic nature of the road network, traffic, weather, and events such as accidents, road repairs, road blockages for any reason, utility company servicing the their underground assets, and so forth, will frequently disrupt the route suggest by the navigation system.

### SUMMARY OF THE INVENTION

The invention in one aspect provides a digital map display method including the steps of determining a position of a display device for the digital map; displaying the digital map at a first scale; determining a number of objects of a required category that occupy a predetermined area of the digital map as displayed; comparing the number with at least one set number of objects; and if the number is different to the set number, changing the first scale to a second scale.

If the number is greater than the at least one set number, the second scale may be smaller than the first scale. However, if the number is smaller than the at least one set number, the second scale may be larger than the first scale. Alternatively, if the number is the same as the at least one set number, the first scale may remain unchanged.

The second scale may be a fixed percentage of the first scale; the second scale being greater than the first scale if the number of objects is less than the minimum number, and is less than the first scale if the number of objects is greater than the maximum number. The fixed percentage is preferably in the range 25% to 75%, more preferably 60% to 70%.

The predetermined area of the display may be a percentage of an area occupied by the display device height and width. Preferably, the percentage is in the range 25% to 100%, more preferably 30% to 50%.

The position may be determined using GPS. The required category may be determined from one or more of multiple layers of the digital map. The digital map is preferably a vector map. The required category may include one or more of: road, parcel of land, lot of land, buildings, places of interest, and intersections. The number of objects may be obtained by a scan of the digital map as displayed.

In another aspect there is provided a digital map display method including the steps:
(a) determining a position of a display device for the digital map;
(b) displaying the digital map at a first scale on a first part of a display screen of the display device; and
(c) on a second part of the display screen of the display device displaying at a smaller scale that part of the digital map surrounding the position.

The first part may be a right display and the second part may be a left display. The left display may be of the exact location within a relatively small geographical area that forms the area immediately around the position in the map of the right display. The split may be horizontal or vertical.

In a final aspect the present invention provides a computer usable medium comprising a computer program that is configured to cause at least one processor to execute one or more functions to perform the steps described above.

### DESCRIPTION OF THE DRAWINGS

In order that the invention may be readily understood and put into practical effect, there shall now be described by way of non-limitative example only a preferred embodiment of the present invention, the description being with reference to the accompanying drawings in which:

FIG. 1 is a schematic view of the system architecture of a preferred embodiment of the present invention;

FIG. 2 is a flow chart of the operation of a system according to one aspect of the present invention;

FIG. 3 is an example of a first map showing a city at a first scale;

FIG. 4 is an example of a map of a city at a second scale; and

FIG. 5 is an example of a split screen display.

### DESCRIPTION OF THE PREFERRED EMBODIMENT

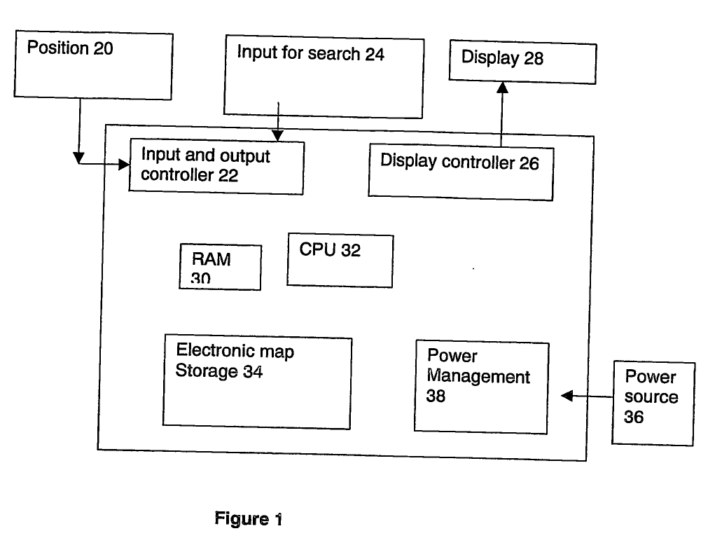

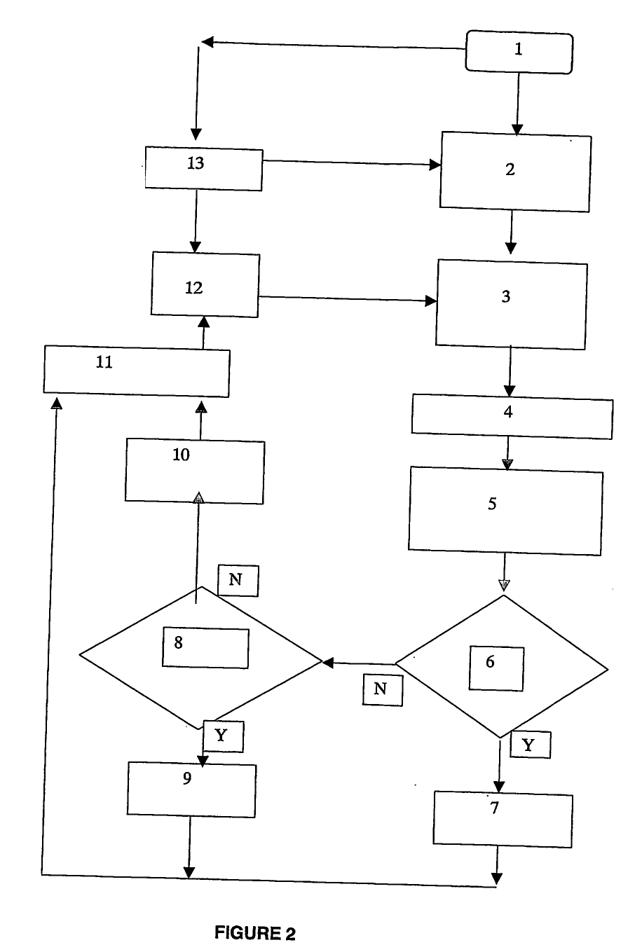

To first refer to FIGS. 1 and 2 there is shown an automatic digital map display zooming method and digital map display zooming device. The display device may be any suitable such device such as, for example, a navigation system including an in-vehicle navigation system, portable digital assistance (PDA), mobile telephone, tablet computer, notebook computer, laptop computer. The common element to all such devices is that they have a display screen. It is the location of the display device that is the important factor as where that is gives to the user their present position, and can give them the information on how to get to their desired location.

FIG. 1 shows that the position determination 20 is input to an input/output controller 22. Also input to controller 20 is a search input 24. The search input allows a user to search for any given location, road, point of interest, building, lot of land, plot of land, or the like, as stored in a database (not shown). The display controller 26 is for controlling the display device 28. RAM 30 and CPU 32 are provided in a normal manner. A storage 34 is provided to store all digital maps that may be required for display. A power source 36 is controlled by power controller 38 in the usual manner.

By determining the number of objects of a predetermined character at the position of the display device by using an external system or external device such as, for example, GPS, a desirable zoom scale at that position will be automatically set using a comparison of the number of objects in an area including the present position, compared with a set number of objects. As a result, the user does not have to deal with or control the operation of the display device to have an understanding of the present position of the display device, and its present direction of travel.

Upon the system being started (step 1), the present position of the display device is determined (step 13) using, for example, GPS, or any other suitable positioning system. In step 12, the longitude (X coordinate) and latitude (Y coordinate) are obtained from the positioning system determination in step 13.

The details of the road map relevant for the present location is loaded (step 2) and displayed at a predetermined scale (step 3). The predetermined scale may be the largest possible scale so that the map can zoom-in easily, a mid-level scale so the map can zoom-in or zoom-out easily, or it can commence with the scale at the level at which it was when the system was last ended.

Upon the map being loaded and displayed, and the coordinates of the present position of the display device input, a timer trigger is started (step 4). The timer preferably operates in counts of whole seconds. By using GPS or other positioning determining system, the location on the map of the present position of the display device can be determined. This position is converted to X (horizontal) and Y (vertical) coordinates on the map as displayed.

In step 5 the system then determines the number of objects that fall within a predetermined category (such as, for example road, parcel, lot, places of interest, intersections, or segments of a road) that occupy a set percentage or ratio of the complete display area. This may be, for example, 33%, or one third of the display area. However, the percentage may be more—up to 100% if required. However, it can't be a very small percentage or in rural areas the map may have no meaning. It is preferably in the range 25% to 100%, more preferably 33% to 50%. This is preferably centered on the present position. However, if the display device is moving, it may be for the percentage in that part of the map ahead of the display device, given its present direction of travel. The number of objects can be determined from the information contained on the map, or from the positioning system.

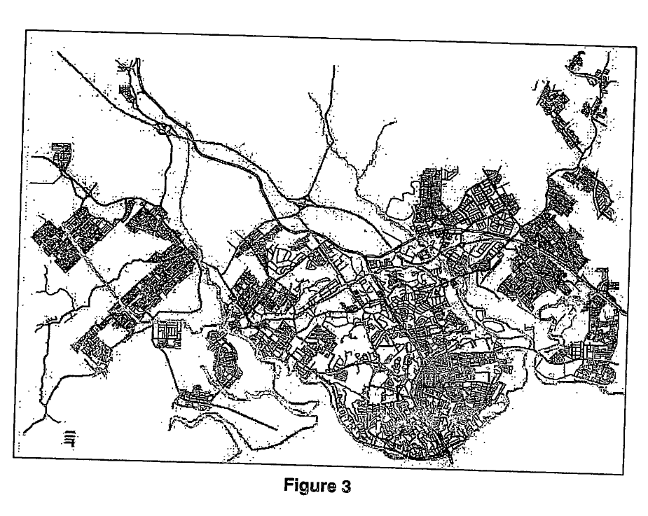

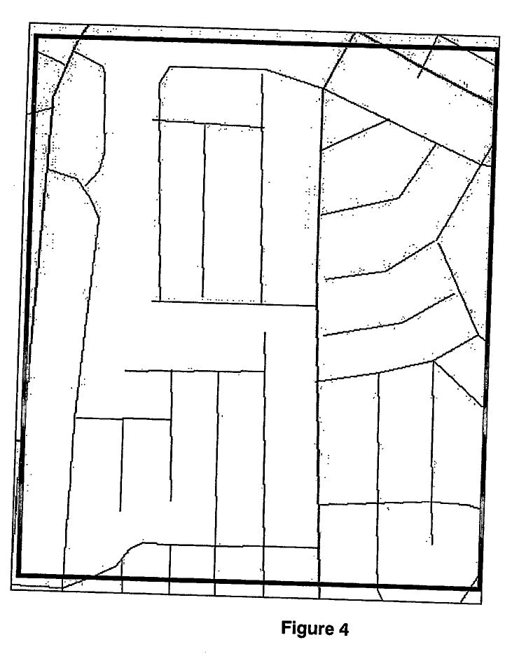

Each digital map is in a plurality of layers. Each layer includes a number of objects. The map of a city is shown in FIG. 3. It consists of 7,138 roads. If the map as displayed showed the entire city, the number of objects displayed will be 7,138. If a small section of a city is displayed, the result will be for far fewer objects to be displayed. In FIG. 4 is shown a map of a small part of a city. The number of objects as displayed is only 26.

To get from the scale of the map of FIG. 3 to a scale of the map of FIG. 4, the number of objects within the map is determined.

In step 6, the question is asked: is the number of objects greater than a predetermined maximum number? The predetermined maximum number may vary according to the locality, type of digital map, the complexity of the digital map, and the nature of the device on which the map is being displayed. The locality may be according to country, region (e.g. state, province, prefecture, or the like), municipality, city, suburb, or other geographical region.

If yes, in step 7 the system instructs the display device to alter the scale by zooming in to the next scale level. This would be a smaller scale level. The smaller scale level is preferably a fixed percentage of the previous scale level. This may be in the range 25% to 75% but is more preferably in the range 60% to 70% of the previous zoom scale.

If the number of objects is not greater than the first set number, the question is asked in step 8: is the number of objects less than a second set number of objects? Again the second set number may vary according to the locality, type of digital map, the complexity of the digital map, and the nature of the device on which the map is being displayed. If yes, in step 9 the system instructs the display device to zoom out to the next scale level. This would be a larger scale level. (e.g. 120% of previous zoom scale)

If the answer to the question in step 8 is no, the system does not provide an instruction to the display device to change the scale of the display so the display remains unchanged (step 10). The system then passes back to step 12.

If the answer to either of steps 6 or 8 is yes, the timer is reset to zero (step 11) and the process passes back to step 12.

The subsequent steps of 3 to 10 are then repeated according to the timer cycle. The timer cycle may be, for example, every five or ten seconds, depending on the processor speed. This happens continuously until the system operation is ended by the number of objects being less than the maximum number, and more than the minimum number.

Therefore, when a map of the scale of FIG. 3 is loaded, the determination of the number of objects will be 7,138. If the percentage is 33%, and the area is the centre of the map, the number of objects may be, for example, 3,000. If this is greater than the preset maximum, the scale will zoom in to the next smaller scale and the timer reset. The number of objects is then recounted. That would be a lesser number. If the scale factor reduction is 60%, the lesser number may be 1,500. If the lesser number is still greater than the maximum number, the process is repeated according to the timing cycle until the number of objects is less than or equal to the predetermined maximum number; and more than or equal to the minimum number—i.e. is in the range of minimum number to maximum number.

The maximum number of objects may be any suitable number such as, for example, twenty, thirty, forty or fifty. The minimum number of objects may also be any suitable number such as, for example, five, ten, or twenty. Either or both numbers may be preset, or be set by user input, or be a combination of them. The only requirement is for there to be a maximum and minimum number, and for the maximum to be greater than the minimum.

Digital maps are normally vector maps. Each object displayed has vector coordinates to enable the system to locate the object on the display. Vector maps have a plurality of layers of display. Each layer will contain objects. If the object as displayed is a point, it will be located by reference to its mapping coordinates X, Y. This is particularly relevant for objects such as, for example, places of interest. If the object as displayed is a line, it will be located by reference to the two points that represent the ends of the line. This is particularly relevant for objects such as, for example, a road, particularly at a large scale. If the object as displayed has multiple parallel lines it will be located by reference to the points that mark the ends of each line. This is particularly relevant for objects such as, for example, roads and highways, particularly at a small scale. For a displayed object that has closed lines (e.g. polygon) it will be located by reference to the end points of each line. This is particularly relevant for objects such as, for example, buildings, parcel of land, lot of land, region, and so forth.

Steps 13 and 2 may happen simultaneously or sequentially, as may steps 12 and 3.

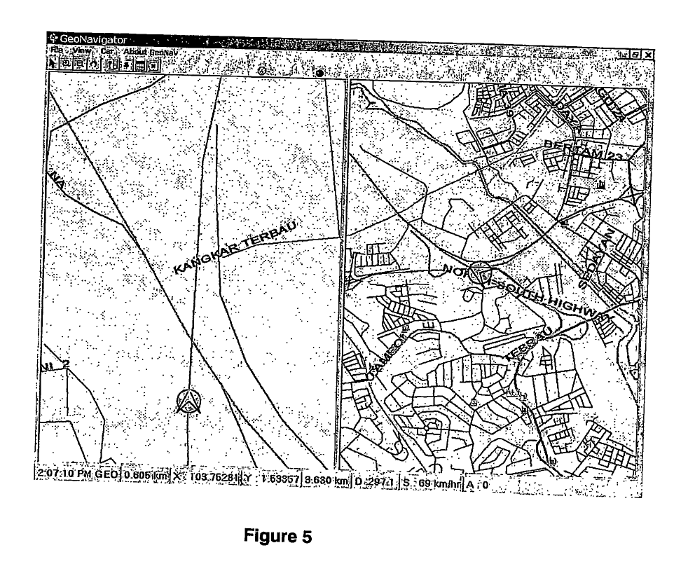

In FIG. 5 there is shown a split display. Here, the left display 14 and the right display 15 have maps at different scales. That of the right screen 15 is a bigger scale than the left screen 14 so a driver or other user can see the “big picture” in right display 15 and know where they are, and where they are headed, relative to a substantial geographical area. The left display 14 is of the exact location within a relatively small geographical area that forms the area immediately around the present location in the map of the right display 15 (as shown by the arrow approximately mid-map). The relative scales may be selected by a user, or may be preset. Whether the right display is at a smaller or larger scale to the left display may be set by the user, or may be preset. The scales of displays 14, 15 are preferably set by using the method described above. Although it is preferred that displays 14, 15 be the same size, they may be different. The split may be vertical as shown, or may be horizontal.

The present invention also extends to a computer usable medium comprising a computer program that is configured to cause at least one processor to execute one or more functions to perform the steps described above.

Whilst there has been described in the foregoing description a preferred embodiment of the present invention, it will be understood by those skilled in the technology concerned that many variations in details of design, operation or construction may be made without departing from the present invention.

The present invention extends to all features disclosed both individually or in any possible permutation and combination.

1. A digital map display method including the steps:
(a) determining a position of a display device for the digital map;
(b) displaying the digital map at a first scale;
(c) determining a number of objects of a required category that occupy a predetermined area of the digital map as displayed;
(d) comparing the number with at least one set number of objects; and
(e) if the number is different to the set number, changing the first scale to a second scale.

2. A method as claimed in claim 1, wherein if the number is greater than the at least one set number, the second scale is smaller than the first scale.

3. A method as claimed in claim 1, wherein if the number is smaller than the at least one set number, the second scale is larger than the first scale.

4. A method as claimed in claim 1, wherein if the number is the same as the at least one set number, the first scale remains unchanged.

5. A method as claimed in claim 1, wherein the at least one set number is a range between a maximum number and a minimum number.

6. A method as claimed in claim 5, wherein the second scale is a fixed percentage of the first scale, the second scale being greater than the first scale if the number of objects is less than the minimum number, and is less than the first scale if the number of objects is greater than the maximum number.

7. A method as claimed in claim 6, wherein the fixed percentage is in the range 25% to 75%, the maximum number is in the range 20 to 50, and the minimum number is in the range 5 to 20.

8. A method as claimed in claim 6, wherein the fixed percentage is in the range 60% to 70%.

9. A method as claimed in claim 1, wherein the predetermined area of the display is a percentage of an area occupied by the display device height and width.

10. A method as claimed in claim 9, wherein the percentage is in the range 25% to 100%.

11. A method as claimed in claim 9, wherein the percentage is in the range 30% to 50%.

12. A method as claimed in claim 1, wherein the position is determined using GPS.

13. A method as claimed in claim 1, wherein the required category is one or more selected from the group consisting of: buildings, places of interest, intersections, road, parcel of land, and lot of land.

14. A method as claimed in claim 1, wherein the digital map is a vector map.

15. A method as claimed in claim 14, wherein the number of objects is determined from at least one layer of a plurality of layers of the digital map.

16. A method as claimed in claim 1, wherein the number of objects is obtained by a scan of the digital map as displayed.

17. A method as claimed in claim 1, wherein the display is a split display having a left screen and a right screen having displays at different scales.

18. A method as claimed in claim 17, wherein the display of the right screen is of a larger scale than the display of the left screen, and the map displayed in the left screen forms an area immediately around the position as displayed in the right screen.

19. A digital map display method including the steps:
(a) determining a position of a display device for the digital map;
(b) displaying the digital map at a first scale on a first part of a display screen of the display device; and
(c) on a second part of the display screen of the display device displaying at a smaller scale that part of the digital map surrounding the position,
wherein the first part of a display screen is of the exact location within a relatively small geographical area that forms the area immediately around the position in the map of the second part of the display screen.

20. A method as claimed in claim 19, wherein the first part is a right display and the second part is a left display.

21. A method as claimed in claim 20, wherein the split is horizontal or vertical.

22. A computer usable medium comprising a computer program that is configured to cause at least one processor to execute one or more functions to perform the steps of claim 1.

23. (canceled)
